(19) United States
(12) Patent Application Publication
(10) Pub. No.: US 2006/0212195 A1
(43) Pub. Date: Sep. 21, 2006

(54) Vehicle data recorder and telematic device

(76) Inventors: Gregory W. Veith, Norristown, PA (US); Thomas W. Ferguson, Bellaire, OH (US)

Correspondence Address: Mr. Thomas W. Ferguson, 54861 High Ridge Rd., Bellaire, OH, 43906, US

(21) Appl. No.: 11/259,686

(22) Filed: Oct. 27, 2005

Related U.S. Application Data
(60) Provisional application No. 60/661,448, filed on Mar. 15, 2005.

(51) Int. Cl. G06F 19/00

(52) U.S. Cl. 701/35; 340/438

(57) ABSTRACT

This invention is a vehicle data recorder with the capability to continuously record and store selected data on both driver and vehicle performance that will include but not be limited to, miles driven, speed, acceleration/deceleration, brake activation, seatbelt usage, vehicle direction, steering anomalies, global position, impact forces and direction, transmission status, and alcohol usage. Specifically, this recorder will have extended data storage capacity, a drunk driver prevention smart ignition, real-time GPS data, low-power cell phone jamming, and internal wireless communication capabilities. It uses microprocessor controlled electronics to record, store, and transmit both driver and vehicle performance data in a date and time stamped file which can be utilized to establish personalized insurance rates, assess road tax and use fees, locate “Amber alert” victims or stolen vehicles, and with it's on scene access, provide critical mechanism of injury information to emergency responders.

### FIELD OF THE INVENTION

This invention in general relates to vehicle data recorders. Specifically, this recorder is a continuous recorder with extended data storage capacity, drunk driver prevention ignition interface, real time GPS data, cell phone jamming, and wireless communication capability, that uses microprocessor electronics to record, store, and transmit both driver and vehicle performance data in a vehicle specific, time and date stamped file which can be utilized to establish personalized insurance rates, assess road use taxes and fees, locate amber alert victims or stolen vehicles, and provide critical mechanism of injury information to emergency responders at the scene of an accident. The recorded data will include, but not be limited to miles driven, speed, acceleration/deceleration, brake activation, seatbelt usage, global position, vehicle direction, impact forces, transmission status, and alcohol usage.

### BACKGROUND OF THE INVENTION

### Prior Art

In any given year, police will report to the NTSB (National Transportation Safety Board) about 7,000,000 automobile accidents, which result in the loss of about 50,000 lives and an economic cost of over $150,000,000,000.00. This invention will reduce the mortality and morbidity of these accidents, reduce the severity and magnitude of the economic losses, provide an electronic accident report, assist in locating amber alert victims and stolen vehicles, and generate large income streams for both government and private industry.

Vehicle data recorders have been the subjects of earlier patents including a patent (U.S. Pat. No. 6,185,490) issued to current applicant and often they have included inputs from brake pedal travel, accelerator position, turn signals, headlights, air bag deployment, video inputs, and engine performance characteristics. Most vehicle data recorders, however, have concentrated on a static laboratory environment and staged accidents using specifically designed test vehicles. Data collection devices used on these test vehicles is expensive, sophisticated, and complicated to use. Some of these devices include:

1. Gyroscopic devices.

2. Laser indicators.

3. Video cameras.

4. Impact sensors.

5. Accelerometers.

The advantages and disadvantages of these devices in a real-world environment are as follows. Gyroscopic devices have proved themselves to be effective and accurate in a laboratory test vehicle, and in aircraft inertial navigation systems. They are, however, expensive, require a relatively long warm up period before stabilization can occur, and they consume a relatively large amount of power. In fact the power consumption of a gyroscopic device would require a complete re-design of the typical motor vehicle electrical system. Lasers also consume large amounts of power and are limited to being a reference from which to measure vehicle distortion after an impact. Video cameras are now being used in some vehicles as stand alone data collection devices, but the cameras focus will always be on the outside events. Specialized impact sensors, and accelerometers fall into the same broad category. They each have a function in a staged accident, but are not of any beneficial use in the real world unless coupled with a more encompassing system like the Vehicle Data Recorder.

Aviation has developed data collection devices that are unique to the demanding aspects of aviation. Flight Data Recorders have proved invaluable to the National Transportation and Safety Board when they had to investigate accidents. The unique and challenging nature of flight, and the tremendous forces that occur in an airplane crash, have contributed to the development of a very sophisticated recorder that is coupled to all essential operating systems in an aircraft that will withstand the tremendous forces of an airplane crash. The system is very expensive, in fact is so expensive that it is not even used in private aircraft

New versions of crash data recorders have additional inputs from video, and GPS. These systems tend to be unifocal and limited in scope to one or two features and do not even attempt to create a fully integrated multi-functional recorder with full two-way wireless communication capabilities and the drunk driving prevention.

Following is a summary of relevant vehicle data recorder patents.

1. Decker et al U.S. Pat. No. 4,533,962.

A method and apparatus for sensing and recording diverse operational and performance characteristics of automotive vehicles and the like has a plurality of transducers directly associated with different mechanical functions of the vehicle for sensing their operating characteristics in relation to time as well as generating analog signals representative of certain functions and combining them with digital signals representing other functions. A signal converter encodes signals from the transducers in predetermined order into digital data signals. Each succession of signals generated is temporarily stored. A recorder than records information stored serially and enables ready access to and identification of each event or condition. After recordation of information over a selected time interval, the recording is automatically erased as additional information is transmitted to the recorder to provide a current history over limited time intervals, such as 30 minutes so as to be especially useful in accident analysis.

The Decker recorder provides a method for sensing and recording numerous operational and performance characteristics of a host vehicle. The Decker system is based on the placement of numerous transducers throughout the host vehicle and associating the electromechanical output of the transducer with the specific vehicle system such as brake pedal travel, and wheel rotation to determine speed. The recorder portion of the system writes to a continuous tape loop discrete blocks of data representing vehicle operation.

2. Zottnik, U.S. Pat. No. 4,638,289

An accident data recorder for short-time recordation and storage of data and events relating to an accident of motor vehicles, comprising pickups for sensing, for example, wheel revolutions to determine the traveled distance and speed of the vehicle. In addition to these wheel sensors, capacitance-based acceleration sensors are provided whose output signals along with the output signals of the wheel sensors and with other status data relating to the operation of the vehicle, are continuously recorded at storage locations of a fixed storage. For this purpose, an addressing logic is provided which operates in a closed counting loop and, as soon as a final address is reached jumps back to the starting address to overwrite the initially stored data. The cyclic data storage is interrupted by the occurrence of a trigger event defining an accident, with the result that the last recorded data, including a predetermined after-travel time, are frozen.

The Zottnik device is basically a short duration recorder that receives input from various sensors located around the host vehicle and uses an addressing logic which operates in a closed counting loop to store data until the final address is reached, at which time it jumps back to the beginning and writes over the previously stored data. When a trigger event occurs such as a vehicle accident the data in storage is permanently stored for later analysis.

3. Takeuchi et al U.S. Pat. No. 4,866,616

Vehicle information such as vehicle speed, engine rotation speed when a vehicle runs are collected and converted into numerical data every constant period of time and these numerical data are written and recorded into memory module. The memory module has therein a non-volatile memory and is detachably provided to a write unit attached to the vehicle. The data writing and power supply to the memory module from the write unit are executed by the contactless coupling using induction coils.

The Takeuchi recorder concentrates on inputs such as vehicle speed and engine rotation and is thus able to concentrate on information as it relates to drive times, drive distances, vehicle speed, and engine rotation. The information is gathered from using electromagnetic induction coils to sense the desired information and relay it to the module where it is recorded into memory.

4. McCracken U.S. Pat. No. 4,992,943

An invention which facilitates motor vehicle accident reconstruction by providing apparatus for detecting and storing data describing the status of a motor vehicle when it is involved in a collision. The invention includes a plurality of impact detectors, a microprocessor which obtains vehicle status data from the computer systems used in modern vehicles, and a memory, such as an EPROM, for storing data for later retrieval.

The McCraken recorder uses the vehicles onboard computer as its' source of data. The obtained data is not stored in memory until one of the many impact sensors located throughout the host vehicle triggers an event. The vehicle status is then stored in an EPROM non-volatile memory for later retrieval and analysis. The chief failing of the Mckracken system is in the use of imbedded microprocessors, which only allow for limited program instructions and an EPROM memory which is essentially a one time recording device until reset by other programming devices.

5. Doyle: U.S. Pat. No. 6,795,759

A secure event data recording system configured for use in a passenger vehicle. The secure event data recording system can include an event data recorder; a memory device coupled to the event data recorder and configured to store event data processed in the event data recorder; and, an input/output port communicatively linked to the memory device through which read/write access can be provided to the memory device. Significantly, a tamper-proof sealing mechanism can be provided which bars access to the memory device, the event data recorder and the input/output port without causing an irreparable breach of the tamper-proof sealing mechanism. The Doyle patent is basically a short duration recorder capable of recording and storing discrete vehicle operational data for later access through a secure communication port.

Rayner: U.S. Pat. No. 6,718,239

Abstract: An event recorder (10) mounted in a vehicle (20) includes sensors, including image sensor (60), sound sensor (90), location sensor (95), and vehicle performance sensors, and a capture circuit for storing sensed data signals around a triggering event. A CPU and program memory (74) are programmed to perform a validation function, such as a one-way hash function, on the captured sensor signal while transferring it to persistent memory device (100) so as to derive a validation value which is also stored in persistent memory device (100). To later verify that the data have not be tampered with, the stored data are operated on by the same validation function so as to derive an audit validation value, the audit validation value is compared with the validation value for equality and the outcome of the comparison is indicated.

The Rayner patent is similar to the Doyle patent in its' reliance upon short duration recordation from a plurality of sensors, unlike the Doyle patent, the Rayner device does not provide a tamper proof mechanism but does provide an audit validation capability.

Otake/Kido: U.S. Pat. No. 6,246,934

A vehicular data recording apparatus records running data regarding a vehicle into a memory in an overwrite manner when the running data needs to be recorded. If the vehicle enters an abnormal state, such as a crash or the like, the apparatus prevents the recording, and retains the running data recorded up to that moment in the memory. The apparatus determines whether the vehicle is in the abnormal state, for example, on the basis of a determination as to whether the vehicle has entered a stopped state within a predetermined time Tc following a time point at which the absolute value of a longitudinal acceleration Gx of the vehicle becomes equal to or greater than a reference value Gx1 and/or a time point at which the absolute value of a lateral acceleration Gy becomes equal to or greater than a reference value Gy1. Alternatively, or in addition, the vehicle is determined to be in an abnormal state based on a determination as to whether the vehicle is in the stopped state and the absolute value of the longitudinal acceleration Gx is equal to or greater than a reference value Gx2, and/or the absolute value of the lateral acceleration Gy is equal to or greater than a reference value Gy2. The Otake/Kido device does not retain any information in permanent non-volatile memory unless the host vehicle has entered into an abnormal state as defined by programmed values such as deceleration forces.

Bague: U.S. Pat. No. 6,246,933

Systems for sensing, storing and updating operation parameters, visual conditions and audible conditions for an automotive vehicle include a plurality of sensors for registering vehicular operation parameters, including at least one vehicle-mounted digital video/audio camera. A microprocessor controller responsive to the vehicle operational parameters which have been registered by the plurality of sensors and video images and audio signals from the video/audio camera is provided for processing the operational parameters and the video images and the audio signals. A rewritable non-volatile memory is provided for storing those processed operational parameters, video images and audio signals, which are provided by the microprocessor controller. The microprocessor controller updates the rewritable memory as new parameters, video images and audio signals are sensed. When the data is converted to computer-readable form and is read by a computer, an accident involving the automobile may be reconstructed. The Bague device differs from previous devices herein referred to by the use of video and audio recorders. It does not have either long-term data storage capacity nor does it have wireless communication capability.

Drunken Driving Prevention.

Drunk driving is one of the leading preventable causes of automobile accidents in the United States and the world. The cost in economic damages, mortality and morbidity of victims is catastrophic. Each of these accidents represent a personal tragedy as well as a cost to society in lost potential and long term medical care to victims. Numerous attempts have been made to devise a means of preventing drunk driving. Law enforcement run checkpoints and/or arrest drivers who are driving erratically. The judicial system has levied fines, suspended licenses, and even imposed jail sentences. None of these efforts have been particularly successful in reducing the number or severity of drunk driving accidents. Numerous attempts have been made to create a device that would detect and prevent drunk driving by disabling the vehicle. The most relevant are:

Bellehumeur: U.S. Pat. No. 6,886,653.

A system and method to prevent a human being from operating a motor vehicle if the human being is intoxicated or under the influence of particular hallucinating drugs that uses a galvanic detector that can measure epidermal (skin) elements of a human being such as alcohol content, sweat and temperature continuously in conjunction with circuitry and logic circuits that connect to the vehicle's ignition system that allow the vehicle to be operated when certain temperature sensing conditions are met and certain conditions requiring no alcohol are met otherwise the vehicle will be turned off. In an alternate embodiment, a glove could be used for epidermal measurements that are also connected to the sensing circuits. The weakness of the Bellehumer device lies in it's cost, method of wiring, and operation requirements. The device is wired in series with the ignition system and could be circumvented by any knowledgeable person using a jumper wire. It also requires the driver to be in constant contact with the steering wheel for temperature sensing requirements which in a cold climate would not permit the driver to wear ordinary cold weather gloves. Finally the device would be cost prohibitive at $600.00 per vehicle in an industry characterized by massive sales discounts.

Ivey: U.S. Pat. No. 5,969,615

This is a system for monitoring and covering the use of hand operated machines by an impaired individual through the detection of toxins emitted in the form of vapors from the operator's hands. The operator is required to pass his/her hand through a sampling device prior to operation of the machine. Upon detection of toxins, the machine is disabled. There is some question as to the accuracy of the device and the overall cost would seem to be prohibitive.

Takeuchi: U.S. Pat. No. 3,811,116.

The Takeuchi device uses a technique known as “Flicker Frequency” to detect driver impairment or fatigue. The cost and complexity of the device and the evolution of technology make this device impractical.

Gaddy: U.S. Pat. No. 3,823,382

Simon: U.S. Pat. No. 4,592,443

Conners: U.S. Pat. No. 4,996,161

The Gaddy, Simon, and Conners devices all use breath analyzers in order to detect alcohol and are impractical because of the ease of circumventing the system by having another individual breathe into the device or the impractibility of having a driver constantly breathe into the device while driving.

Other patents considered relevant are included by reference:

| | | |
|---|---|---|
| 1. | Ishigami | patent#5,311,430 |
| 2. | Camhi et al. | patent#5,430,432 |
| 3. | Yamawaki | patent#5,446,659 |
| 4. | Nishio | patent#5,541,590 |
| 5. | Woll et al. | patent#5,581,464 |
| 6. | Cuddihy et al. | patent#5,608,629 |
| 7. | Kikinis | patent#5,815,093 |
| 8. | Otake/Kido/Gotenba | patent#6,246,934 |
| 9. | Takeshi/Tadashi | patent#6,298,290 |
| 10. | Dubois | patent#4,613,845 |
| 11. | Ivey | patent#5,793,292 |

None of these devices, however, do an adequate job of providing relevant information as it relates to a vehicle accident in a comprehensive self-contained cost effective modular format. Neither do any of the prior inventions provide an electronic means of vehicle identification, ignition security, drunk driving prevention, two-way wireless communication or a real world date and time and GPS position of a vehicle. The prior inventions also fail to provide a means of long-term data storage and processing. The prior inventions also fail to provide for an internal backup rechargeable battery power source necessary to prevent loss of data prior to transfer to the non-volatile memory.

Cell Phone Communcation in a Moving Vehicle.

Recent reports by the NHTSA indicate that cell phone usage in a moving vehicle has overtaken drunk driving as the leading cause of automobile accidents. If the wireless industry projections are accurate, then we can expect automotive usage to increase and automobile accidents to increase. Several states have recently passed laws making the use of a cell phone sans a hand free device illegal. The present invention will address the illegal usage of cell phones in an automobile by activating a low power carrier frequency jammer that will be effective at blocking cell phone usage with in the interior of a car unless certain pre-determined conditions are met. At this time, cell phone jammers that have been designed are a high power area jammer that is indiscriminant and illegal. Several such designs are available on the Internet, but there appears to be no legal low power jammer being designed and no available patents for such devices. The only available prior art consist of these Internet designs, college project designs and sub-culture wishful thinking designs. The present invention is the first to concentrate solely on automotive usage of cell phones and would appear to be in compliance with FCC regulations because no attempt is made to prevent legal use of a cell phone and adequate safety precautions are taken to prevent even accidental interference with cell phone usage outside the interior of the automobile.

Telematics

Telematics (communication with a mobile source) has greatly expanded since 1998. Numerous patents have been issued that deal with various aspects of vehicle and occupant status and communicating this information with a host. On Star is perhaps the most well known and has features that include voice communication, navigation systems, GPS data and to a degree vehicle control from a distance i.e. remote unlocking of a door. Numerous other devices have provided navigation services, vehicle diagnostics and real time traffic monitoring. Some of the more important patents in this field are:

Diltz et al. U.S. Pat. No. 6,249,215

A process and an arrangement for shutting down a vehicle by means of a shutdown signal is the result of a shutdown request. During a vehicle-side analysis, a conclusion is drawn from a current vehicle operating condition and/or a current vehicle location according to defined criteria regarding a shut-down site which is safe with respect to traffic and/or a traffic-safe shut-down site is recognized, in which case the shut-down signal is not generated before the current vehicle operating condition represents a traffic-safe shut-down site and/or before the current vehicle location corresponds to a traffic-safe shut-down site.

Pertz et al. U.S. Pat. No. 6,266,608

When a motor vehicle (1) is being driven, traffic information (5), which relates exclusively to its individual route of travel can be transmitted to the vehicle driver. Traffic information which does not apply to this area is suppressed. The traffic information is selected automatically and as a function of a time-dependent movement profile of the motor vehicle. The respective areas for which traffic information is desired thus no longer need be predetermined manually, so that no time-consuming setting processes are involved, and safety while driving is increased.

Bochmann, et al. U.S. Pat. No. 6,282,491

A telematic device in which a car radio with an RDS module, a wireless telephone, and a positioning and navigation system are provided in one housing. The housing is designed so that it can be installed in a standard bay in the instrument panel of a motor vehicle. The telematic device can be used to receive general information via the car radio as well as specific information via the GSM module. In addition, data relating to, for example, the vehicle position, a desired destination, or an emergency call can be sent to the central station. The central station calculates one or more routes and transmits them back to the telematic device. In the event of an accident or a vehicle breakdown, an emergency call is transmitted and assistance obtained. Additional telematic services provided include an expanded anti-theft system for the motor vehicle, hotel reservations, etc.

Hurta, et al. U.S. Pat. No. 6,317,721

This invention allows a toll authority to monitor transaction numbers, which are sent from a transponder (14) to an interrogator (12). By incrementing the transaction counter stored in the transponder with successful transactions the toll authority can ascertain whether accounting of a transaction has been missed (i.e., a transaction number missing from the sequence), or double-counted (i.e., two transactions with the same transaction number).

Otto U.S. Pat. No. 6,459,967

Device for controlling and monitoring a vehicle having a first system having radio/driver information for example for positioning and/or navigational aids and a second system for evaluating data for vehicle technical operating statuses, in which the two systems are linked together in such a way that the data supplied by a single sensor are evaluated in both systems for different purposes.

Winter, et al U.S. Pat. No. 6,473,691

The invention relates to a method for operating a navigation system comprising a digital map base, which is a representation of actual geographical areas and which contains data of geographical elements. The navigation-system also comprises a unit, which retrieves and processes the data, such as an operating unit provided with a display device. The data in the digital map base is combined in the form of geographically defined page frames. When requesting a page frame from the digital map base, data of geographical elements which extend beyond the edge of the page frame is transferred in such a manner that data pertaining to these geographical elements located outside of the requested page frame is also compiled and transferred.

Osterling U.S. Pat. No. 6,542,818

The invention provides a method for creating a real-time recording of a mobile vehicle route using a wireless communication system. The recording is initiated by the driver of the vehicle. Positional information is obtained for the vehicle at set time intervals using a global positioning system. The positional information is recorded by an on-board system and saved along with a nametag assigned by the driver. The vehicle initiates a call to a predetermined number and uploads the recording to a central storage location. The recorded route is displayed on a Web site and can be viewed and modified by an identified user.

Kerner, et al. U.S. Pat. No. 6,587,779

In a method for monitoring and controlling traffic states in a road traffic system current or predicted traffic states are determined for one or more points and a distinction is made between the three types of traffic states: free-flowing traffic, slow-moving traffic and stationary traffic. Vehicle inflow into the traffic system is then controlled as a function of the detected traffic states. The state monitoring method is configured to detect phase transitions between free-flowing and slow-moving traffic and/or stationary traffic states, which can be detected or predicted by means of specified criteria. Furthermore, according to the invention the vehicle inflow into the monitored traffic system section is controlled as a function of detected phase transitions between free-flowing and slow-moving traffic

Myr U.S. Pat. No. 6,615,130

Real time vehicle guidance by central traffic unit is provided by a system, which includes a central traffic unit, a plurality of vehicles equipped with mobile guidance units, and communication system based on GSM/GPS technology. The central traffic unit maintains the perpetually updated database of travel times for all sections of roads, while mobile guidance units include mobile cell phone handset units communicatively linked to the central traffic unit computer server. Mobile guidance units also comprise smart card capable to detect when a mobile cell phone unit is located in the mounting receptacle. To detect a bottleneck situation when it arises and to estimate a current travel time for a corresponding section of road, the central traffic unit maintains a list of probe vehicles that have recently exited that section. If the times those vehicles have spent on the section differ considerably from a regular travel time stored in the database, the central traffic unit uses statistical tools for forecasting the future travel time along this section. By appropriately combining those travel times, the central traffic unit calculates the fastest route based on the most updated information on traffic load disposition. The guidance system also allows the driver to enter alternative time schedules for the same destination and receive alternative travel time estimates reflecting different estimated travel times along the roads at different times.

Breed, et al. U.S. Pat. No. 6,662,642

Wireless sensing and communication system including sensors located on the vehicle or in the vicinity of the vehicle and which provide information, which is transmitted to one or more interrogators in the vehicle using wireless radio frequency transmission technology. Power to operate the sensor may be supplied by the interrogator. The sensors include tire pressure, temperature and acceleration monitoring sensors, weight or load measuring sensors, switches, temperature, acceleration, angular position, angular rate, angular acceleration, proximity, rollover, occupant presence, humidity, presence of fluids or gases, strain, road condition and friction, chemical sensors and other similar sensors providing information to a vehicle system, vehicle operator or external site. The sensors provide information about the vehicle and its interior or exterior environment, about individual components, systems, vehicle occupants, subsystems, or about the roadway, ambient atmosphere, travel conditions and external objects.

Breed, et al. U.S. Pat. No. 6,735,506

Vehicular telematics system including an occupant sensing system for determining a property or characteristic of occupancy of the vehicle constituting information about the occupancy of the vehicle and a communications device coupled to the occupant sensing system for transmitting the information. The occupant sensing system may include sensors, for example, an image-obtaining sensor for obtaining images of the passenger compartment of the vehicle, a motion sensor, receivers arranged to receive waves, energy or radiation from seating locations in the passenger compartment, heartbeat sensors, weight sensors associated with seats in the vehicle and/or chemical sensors. Vehicle sensors may be provided, each sensing a state of the vehicle or a state of a component of the vehicle. The communications device is coupled, wired or wirelessly, directly or indirectly, to each vehicle sensor and transmits the state of the vehicle or the state of the component of the vehicle

Kohut, et al. U.S. Pat. No. 6,741,931

A vehicle navigation system communicates with a remote navigation server to download turn-by-turn command information via a mobile phone communication channel. After the mobile phone is disconnected from the remote server, an on-board transceiver module generates turn-by-turn command information to the vehicle operator in voice and/or visual form.

King, et al. U.S. Pat. No. 6,895,332

An emergency vehicle alert system includes a first GPS receiving unit provided on the emergency vehicle that determines emergency vehicle location information of the emergency vehicle; a transmitter unit provided on the emergency vehicle that transmits the emergency vehicle location information by way of an emergency vehicle location signal; a second GPS receiving unit provided on the motor vehicle that determines vehicle location information of the motor vehicle; a receiver unit provided on the motor vehicle that receives the emergency location signal output by the transmitter unit of the emergency vehicle; and a map display that displays a current location of the motor vehicle and a current location of the emergency vehicle. The emergency vehicle is shown as an icon on the map, whereby the icon has a different visual characteristic depending on the position of the emergency vehicle with respect to the motor vehicle.

Remboski, et al. U.S. Pat. No. 6,925,425

A method of assessing vehicle operator performance includes the steps of receiving vehicle operating data (502); monitoring an interior portion of the vehicle and receiving operator activity data from the interior portion vehicle (504); receiving vehicle environment data from the environment external to the vehicle (506); monitoring the vehicle operator and receiving operator condition data (508); and determining an operator assessment value (510). The operator assessment value is based upon the vehicle operating data, the operator activity data, the environment data and the operator condition data and is indicative of vehicle operator performance.

Other patents considered relevant are included by reference:

| | |
|---|---|
| Holmes, et al. | Patent # 6,751,475 |
| Ablay, et al. | Patent # 6,765,497 |
| McCarthy, et al. | Patent # 6,768,420 |
| Takano, et al. | Patent # 6,856,904 |
| Sziraki, et al. | Patent # 6,912,396 |
| Osterling, et al. | Patent # 6,933,842 |
| Fraser | Patent # 6,947,732 |

### SUMMARY OF THE INVENTION

It is therefore an object of this invention to provide for a novel and improved method and means for measuring and recording vehicle and driver performance characteristics analyze the same and report via wireless network to a host computer for use in subscriber insurance programs, road usage taxation, stolen vehicle location, and the location of amber alert victims.

It is a further object of this invention to provide a novel and improved cost effective method and means of measuring and recording vehicle status prior to, during, and subsequent to a trigger event, which will be accurate and reliable, easy to install, and can be retrofitted to existing vehicles.

It is a further object of this invention to provide a novel and improved self-contained rechargeable power source for the purpose of completing the file routine and transferring same to a non-volatile memory device if a power interruption occurs either through cessation of vehicle operation by operator action or the occurrence of a trigger event that disrupts the vehicle electrical system.

It is another object of this invention to provide a novel and improved method and means of determining vehicle speed, direction, and location at all times.

It is a further object of this invention to provide a novel and improved method and means of correlating all discrete events in relation to actual date and time of occurrence and recording same.

Another object of this invention is to provide a novel and improved method and means of identifying and storing vehicle specific data files by correlating and incorporating the unit serial number in all files, which can be correlated with the vehicle identification number stored in the host computer.

Another object of this invention is to provide for a novel and improved method and means of identifying either a side to side, or front to back vehicle rollover through the coordinating and comparing the data from the tilt meter and the electronic compass. A side-to-side rollover would be indicated by activation of the tilt meter without significant change in the compass heading readings. A front to back rollover would be indicated by activation of the tilt meter coupled with a 180-degree compass flip.

It is a further object of this invention to provide a novel and improved method of subscriber automobile insurance by analyzing a driver's data to determine how “safely” the driver operated the vehicle, assess the level of risk posed by the operation of the vehicle, store that information in a non-volatile memory and transmit the data on a regular periodic basis to a host computer where ultimately the driver will be billed according to how safely he operates the vehicle.

At the end of each month, the unit initiates a cellular telephone call to transmit this data over the wireless system to a regional data center where billing statements are created.

It is a further object of this invention to significantly reduce drunk driving and automobile theft by using a novel and improved means of driver identification, and determination of impairment. In one embodiment of this invention the “smart ignition system” will be comprised of in a numeric pad for input of personal identification number (PIN), a means of biometric identification, such as fingerprint scanning, and galvanic sensors to take trans-dermal readings of the skins conductivity in order to measure the level of alcohol or toxins in the driver's system.

It is another object of this invention to provide a new and novel means of vehicle location for the purposes of amber alert or national security. In one embodiment of this system a full duplex wireless communication capabilities with GPS will permit the host computer to inquire on the status and location of a vehicle of interest.

It is a further object of this invention to prevent the use of all wireless transmissions from the interior of a vehicle in the absence of pre-determined conditions. In one embodiment of this invention that would include but not be limited to a hands free device, transmission status of park, airbag deployment or impact exceeding pre-determined g-forces, or system communication.

It is a further object of this invention to provide the capability to fully integrate communications from future smart road systems.

### BRIEF DESCRIPTION OF THE DRAWINGS

This invention can be understood and is described in greater detail by reference to and in connection with the accompanying drawings.

FIG. 1 is a schematic representation of the overall invention showing one of the preferred embodiments of a vehicle data recorder/automotive telematic device.

FIG. 2 is a functional block diagram showing one of the preferred embodiments of a drunk driving prevention ignition system.

FIG. 3 is a schematic rendition showing one of the preferred embodiments of a low power automotive cell phone-jamming transmitter.

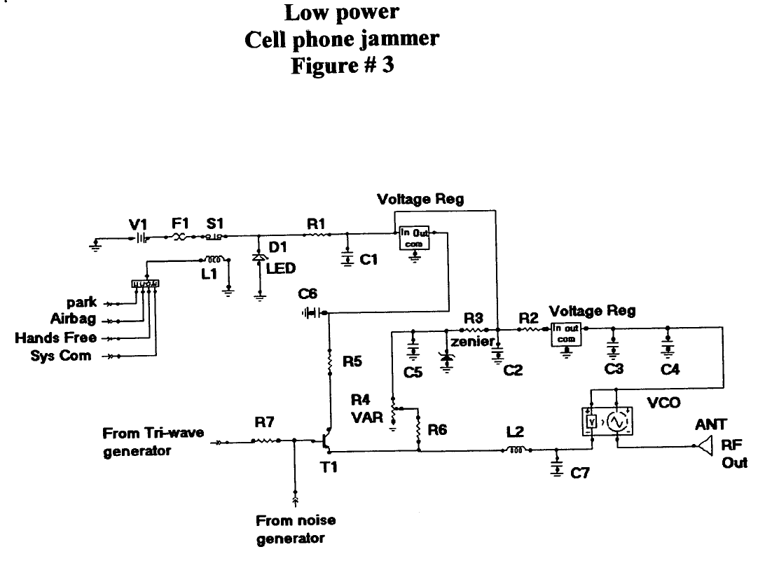

### DETAILED DESCRIPTION OF THE INVENTION

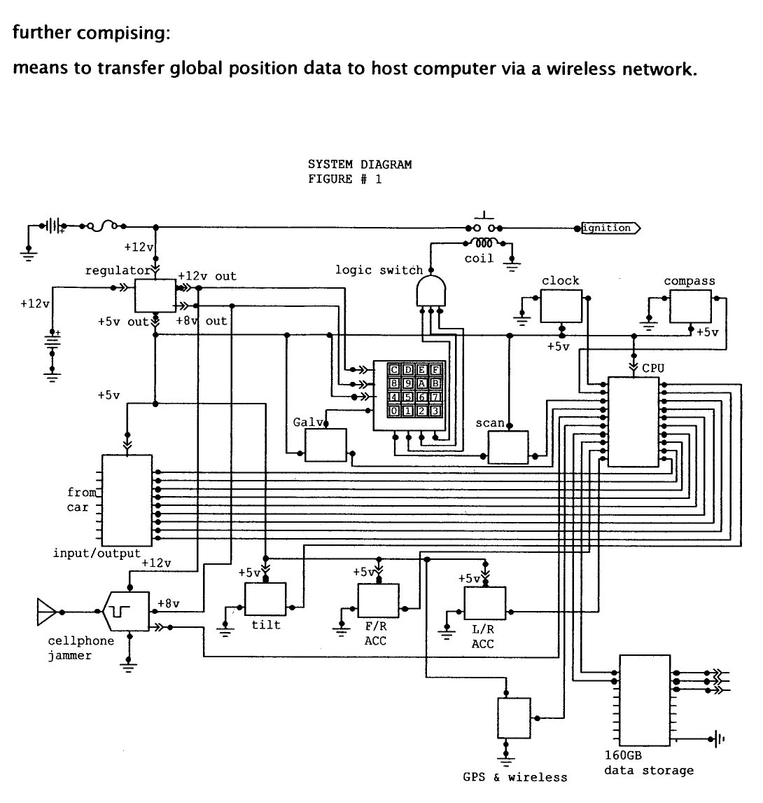

FIG. 1 is an overview of the entire system. The automotive battery provides 12 vdc to a three-output voltage regulator and to one side of a normally open switch. The voltage regulator outputs three separate regulated voltages, +5 vdc, +8 vdc, and +12 vdc. The +12 vdc constantly energizes the numeric keypad, which is used to enter the authorized drivers personal identification number. If a correct number is entered, a contact will close and place 12 vdc to one of three terminals on a 3-input switch (logic “and” gate). The driver would next have to place an identifying digit on a scanner for fingerprint identification and galvanic sensor readings for a time interval of 3 to 5 seconds. If a correct fingerprint is scanned, a contact will close and allow a +8 vdc to the second terminal of the 3-input gate. A clear reading (below the programmed legal limit for that area) from the galvanic sensor will allow +5 vdc to be placed on the final contact of the 3-input gate. When all three distinct voltages are present, the gate will energized a coil causing the normally open switch to close and pass +12 vdc to the cars ignition system. Once the car is started, power will be applied to all external and internal sensors. External sensors will include inputs from the speedometer, the transmission status (i.e. forward, reverse, or park), seatbelt usage, brake activation, use of hands free cell phone device, front passenger seat belt usage, rear passenger compartment usage, It is to be understood that variations in the arrangement and number of external sensors is covered by this description. The internal sensors, “tilt”, “front/rear accelerometer. left/right accelerometer, hard disk data storage, CPU, and the combined wireless/GPS system are provided with a +5 vdc. The low power cell phone-jamming transmitter requires +12 vdc and +8 vdc, which are provided through the numeric keypad upon the entering of a correct PIN.

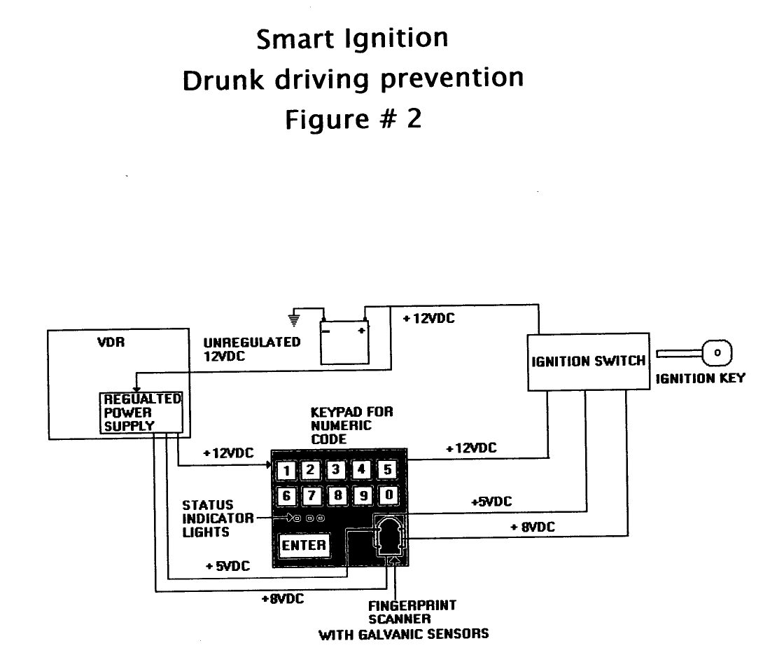

FIG. 2 shows the arrangement of the components of the “smart ignition system”. +12 vdc is provided to the voltage regulator, which distributes at least three positive voltages to the system. +12 vdc energizes the number keypad upon which a driver will have to enter a correct personal identification number, which can be programmed, into the system. A successful PIN will close a switch and pass the +12 vdc to one terminal of a Logic (three-input” AND gate, and allow the +5 vdc to energize the fingerprint scanning screen and the galvanic sensors. If the driver scans a correct fingerprint, +5 vdc will pass through and be applied to the second terminal of the AND gate. If the galvanic sensor reading is such that no or below legal limits of alcohol are detected, +8 vdc will be applied to the third and final terminal of the AND gate. When this happens, +12 vdc will pass through the gate to energize an induction coil, which will cause the normally open switch to close allowing the cars ignition system to activate.

Figure three is a schematic of a low power cell phone-jamming transmitter. The transmitter is connected to power through the smart ignition system. +12 vdc is provided through the system voltage regulator and is connected to one terminal of the voltage-controlled oscillator of the type used in cell phones. The +8 vdc is connected to the input of a triangle-wave generator and a noise generator, and the emitter of transistor Q1. A variable capacitive/resistive network is used to tune the output of the voltage-controlled oscillator (VCO). The outputs from the triangle-wave generator and the noise generator are applied to the base of transistor Q1. The +8 vdc on the emitter of transistor Q1 biases the transmitter and allows the output on the bas to pass through the collector to the VCO. The tuned output of the VCO is swept up and down the specified frequency range by the output of the triangle-wave generator and the output of the noise generator is passed through to the antenna effectively blocking the tower carrier frequencies. The transmitter will block all cell phone usage in the interior of the car except for four specific events.

1. The transmission is in park.

2. The air bags deploy and emergency communications are required.

3. The vehicle data recorder is in communication with the host computer.

4. A hands-free device is used.

When any one or combination of these events occurs, a blanking pulse is sent to the transmitter to turn off the output.

It is clear from the preceding discussion that in one of the preferred embodiments of this invention a convergence of the system and methodology of the insurance industry, the wireless industry, and the government road use management and taxation is contemplated. This convergence will result in increased revenues by accessing billions of dollars in new revenue for the auto insurance industry by reducing or eliminating uninsured drivers and insurance fraud. At the same time it will lower consumer pricing by billing each driver for actual driving behavior.

The primary component is an event data recorder in which we already enjoy a patent [U.S. Pat. No. 6,185,490]. Unlike other recorders, however, our recorder enjoys extended time recording and extended memory capacity; given the present quality of memory chips we could store 10 years worth of driving information. The information to be recorded consists of, inter alia, miles driven, speed, acceleration, deceleration, frequency of brake use, lane changes, and measures G-forces placed on the physical structure of the vehicle. Additionally, we contemplate monitoring how many occupants are in the vehicle, and whether the driver has been drinking alcohol. Generally speaking, we intend to record, transmit, and analyze any and all information, which an insurer would find relevant to assessing risk.

The driver-performance data recorded by the first component will be transmitted to a second hardware component embedded within the first device [so it would survive an accident]. This second component utilizes a microprocessor, which is programmed with an operating system platform from which competing insurers can apply their own unique billing software.

It will allow insurers to easily collate, analyze, and then transmit the information via wireless to regional data centers where billing statements will be created.

Our system will analyze the driver's data to determine how “safely” the driver operated the vehicle, assess the level of risk posed by the operation of the vehicle, and ultimately bill the driver accordingly. The insurance bill will be tied directly to how the car was operated. The proverbial “little old lady who drives her car to church and back” would pay very little in auto insurance. A similar but less drastic example would be the teenager who receives a license, but has no regular access to a vehicle. Under our system, while this teenager would still be charged a higher “base” rate due to his inexperience, he would pay very little if he drove very little; and nothing if he didn't drive for the entire billing period. Moreover, if the teenager drove safely at all times then the bill would not be very high even at the higher “base” rate for new drivers. Our system gives teenagers an immediate [that month] incentive to drive safely.

At the end of each month, the second unit then initiates a cellular telephone call to transmit this data over the wireless system to a regional data center where billing statements can be created.

In addition to the benefits our system contemplates for both consumers and the auto-insurance industry, it also presents excellent revenue opportunities for governments, the wireless industry, and general economies as well. Our system can be used to replace toll collectors with a far more efficient—and lucrative—method of taxing the roadway system. Our system simply records miles driven, and then transmits this data via wireless network to a regional data center where a road-tax bill can be created. In the United States for instance, at a tax-rate of one-penny-per-mile the federal government would realize thirty billion dollars annually which is twenty-five billion dollars more than is now generated through tolls, and these new revenues provide a dedicated revenue source for road maintenance. These new revenues could assure each state receives no less than double the road funding they now receive. Again, these new road revenues will be attractive to the Chinese [and India] governments as well, as they seek funding for the road development. Finally, the complete elimination of tolls around the world will reduce road congestion and stimulate economies.

The wireless industry also stands to benefit financially. Both our auto insurance service and the road-taxing service require a wireless network to transmit data. In return for facilitating these simple wireless transmissions, the wireless provider would receive user-fees. With two hundred million cars in the United States, user fees of $2.00 a car each month would generate “new” wireless revenues of more than five billion dollars a year. Moreover, the wireless transmission burdens are so minimal [one 1-2 minute cell-phone call each month per car] that this new multi-billion dollar revenue stream can be generated with no significant additional burden to the existing wireless infrastructure.

Notably, we are developing our hardware in anticipation of the day when improvements in wireless speed and capacity allow for real-time recording, analysis, and transmission—as well as receipt—of any and all insurance-relevant information. In other words, we anticipate the day when an outside information such as a “safe-driver profile” can be programmed into the device, and thus have the “actual” driver performance measured against the “safe-driver” profile. Under this scenario the insurance bill will be measured by deviation from the “safe-driver” profile, the greater the deviation, the higher the insurance bill. Our device could also receive information from “smart” roads designed to transmit information to cars on the roads.

The United States government is presently addressing a highway bill where funding is a major concern. Using our patented technology and business method, we propose to generate an additional twenty-five billion dollars a year for government. In 2003 Americans drove approximately 2,760,000,000 miles. If the government charged one penny-per-mile in 2003 as a usage tax, then it would collect approximately 28 billion dollars. Revenues would be well over 30 billion dollars if heavier vehicles [which tax the roads more severely] were taxed at higher rates; for instance, 18-wheelers could be charged two-cents per mile on certain roads. While such an increase is justified based solely on the obvious burden such vehicles place on the roadway system, it is further justified by delays large trucks cause in metropolitan areas. The federal government could then distribute these increased revenues among the states based on historical needs concerning road maintenance, and promise states no less than double their present funding.

Again, while some consumers might ultimately pay more in road-taxes, they would not go without benefit. First, the removal of tolls would increase traffic flow and reduce time wasted in traffic jams. A 2002 study by the Federal Highway Administration [US] concluded that the American economy suffered annual losses of seventy-two billion dollars due to traffic jams. The FHA's most recent study for 2003 indicated losses of approximately eighty-five billion dollars. With this in mind, an increase in traffic flow and reduction in traffic jams benefit consumers by stimulating the economy and creating new jobs.

Most importantly however, by eliminating fraud, seller fees, uninsured drivers, and significantly reducing drunk driving costs, the introduction of wireless based auto insurance would significantly reduce auto insurance premiums, and these reductions will more than make up for the additional taxes paid for road use.

The auto insurance industry within the United States receives approximately two hundred billion dollars a year in premiums. According to our research these premiums are spent in the following approximate manner: 1) ten percent [approximately twenty billion dollars] is spent on medical payments; 2) seventeen percent is spent on property damage [thirty-four billion]; 3) sixteen percent [thirty-two billion dollars] is spent on selling expense such as commissions, etc.; 4) fourteen percent [twenty-eight billion] goes toward attorneys fees; six percent [twelve billion] goes toward pain and suffering claims; and 5) two percent goes toward wage loss claims. The industry also claims annual losses of thirty billion due to fraud.

We expect auto insurance premiums to be lower for the following reasons: 1) elimination of uninsured drivers so the insurance industry would collect premiums from another fifteen to twenty million drivers; even at the reduced rates we intend to charge, this creates an additional ten billion dollars a year; 2) total elimination of $30 billion dollar fraud problem; 3) significant reduction in “seller related costs” [commissions] of thirty billion dollars; and 4) a significant reduction in traffic accidents including a significant reduction in drunk driving. Consumers will pay far less for auto insurance because our technology will save the industry [conservatively] fifty billion dollars a year and these savings will be passed on to consumers. Also, auto insurance costs will be more manageable for low-earners because they will be paid over twelve months.

Drivers will drive more safely because their insurance bills are directly related to how safely they drive, and this will result in significant “indirect” savings to the insurance industry and the economy overall. Today drivers face increases in car insurance only in the relatively rare event they are involved in an accident. However as regular road travelers know well, there are many irresponsible drivers who—while they somehow avoid accidents—make the driving experience less enjoyable and more dangerous for others. Under our system, drivers who speed, make frequent lane changes, accelerate too quickly, brake often and too hard, take turns at dangerously high speeds, etc., will pay higher premiums for their actions regardless of whether they arrive at their destination without incident [accident].

Similarly, a person who drives under the influence of alcohol will pay for the increased risk he posed the insurer regardless of whether he arrives safely.¹ Moreover, the insurer will know how often the insured gets into the car after consuming even minimal amounts of alcohol. Nothing would prevent the insurer from charging higher insurer rates as they come to recognize the insured as an increased insurance risk.

Similarly, dangerous driving activities such as drag racing would be significantly reduced, as people will pay extremely high prices for engaging in such conduct regardless of whether law enforcement detects their activities. Under our system, nobody gets away with creating a risk, even if the risk does not result in an actual accident. This should significantly reduce accidents.

As a consequence of overall safer driving, the auto insurance industry should have lower expenditures for the following: 1) property damage [cars]; 2) medical payments for injuries; 3) attorneys fees; 4) wage loss payments; and 5) pain and suffering payments.

Based upon the Insurance Institute numbers, a 20% reduction in accidents would result in the following savings: 1) medical costs: $4 billion dollars; 2) property damage: $6.8 billion dollars; 3) collision claims: $6.8 billion dollars; 4) pain and suffering: $1.2 billion dollars; and 5) wage loss: 800 million dollars. Even a modest ten percent (10%) reduction would result in billions of dollars in savings to the insurance industry.

Finally, in addition to direct savings to the insurance industry, the National Highway Safety Administration recently determined that the American economy suffered an overall loss of 200 billion dollars due to car accidents. Given these numbers, any reduction in the number and severity of accidents will have a significant effect not just on the auto insurance industry directly, but the American economy indirectly. These same savings will be available in other countries as well. When any population is charged higher insurance because of driving habits that create more risk, then the population will learn to create less risk.

In addition to the direct savings associated with a reduction in accidents, our system would eliminate fraud and lawsuit abuse. Today, the American auto insurance industry estimates that auto insurance fraud costs them approximately 30 billion dollars a year. With our technology—assuming our technology is in all cars—it will be virtually impossible for criminals to falsify claims. Our technology will quickly develop a library of accident profiles based on model, weight, speed, angle, etc. which will make it difficult—if not impossible—for criminals to successfully file and collect on false claims which significantly deviate from our accident profiles. Moreover, even if we reduce fraud by only 60-70%, we will save the auto insurance industry an additional twenty billion dollars a year.

According to the National Highway Safety Administration, approximately fourteen percent of drivers are uninsured, and responsible for over four billion dollars in industry losses in 2003. With approximately two hundred million drivers, this means there are approximately twenty million uninsured drivers in the country.

Using our new technology, there will be ZERO uninsured drivers. Each driver will be automatically enrolled in an insurance plan at the time the vehicle is registered with the State Motor Vehicle Agency. At the very moment the state issues license plates and tags, the state will now include auto insurance. It will be impossible to drive a registered car that is not insured. Even if these motorists accumulated insurance bills of only $400.00 for the entire year this would mean at least ten billion dollars in “new” premiums [CASH] for the insurance industry.

Approximately fifteen percent [or thirty billion dollars a year] of United States insurance premiums go towards commissions, salaries, benefits, and other selling related expenses. Our system would largely eliminate seller-related expenses, as drivers would automatically be insured when they register their cars with the state motor vehicle departments. While there would be “up-front” costs to integrate the registration network with the insurance network, as well as annual monies to the state to handle increase in administrative duties for state agencies, these costs are minimal in relation to annual savings to the insurance industry by eliminating commissions, etc.

There is no compelling reason to pay thirty billion in auto insurance sales-commissions when auto insurance is a government requirement. If people must by law carry insurance, then we propose to have the government issue the insurance at the time the car is registered. The consumers can make their decision on a carrier at the registrar's office, or even better, before they arrive.

We intend to install a three-prong system to significantly reduce drunk driving. In order to start the vehicle, the operator will have to enter a personal identification number on the numeric keypad referred to in FIG. 2 and then provide a fingerprint on a pad placed on the dash. The fingerprint technology will recognize the operator as an authorized driver. The fingerprint scanner and the keypad will send two distinct voltages to the ignition system allowing for starting.

Both the fingerprint reader and the keypad will contain galvanic sensors to measure the electrical outputs. By having just 2-3 seconds of contact with the operator's skin, these galvanic sensors will be able to detect alcohol levels to a high degree of reliability. If the person measure greater than a certain level [for instance 0.08] then the vehicle will not start. Again, a third and final distinct voltage signal will be sent to the ignition system to clear the car for operation. Because we utilizing three distinct voltage signals, it will be extremely difficult for anyone—let alone a drunk person—to circumvent the system.

Furthermore, while an operator can start a vehicle with less than 0.08 blood alcohol levels, their insurance bill for such operation may make them wish they had not started the vehicle. That will certainly be the case if political concerns prevent our system from use the capability of disenabling the vehicle. That is, if a driver operates his car at greater than 0.08 then even if he arrives home safely his insurance bill will make him wish he hadn't started the car.

The fingerprint technology and the galvanic sensor technology are both reliable and simple. Indeed, the entire cost of our device will be less than $200.00 per vehicle. The likely reduction in drunk-driving and drunk-driving accidents should result in billions of dollars in savings to the insurance industry and to the American economy.

Under our wireless auto insurance system—and including the penny-per-mile road tax—we expect people will drive less just as they moderate their use of air-conditioning, heating, electric, etc. Consumers will drive less because driving less will translate into lower insurance costs. A reduction in driving combined with elimination of tolls will further reduce traffic congestion and further stimulate the economy.

As people drive less to save on insurance [and avoid road taxation], they will conserve gasoline. This becomes more significant given the rising price of gasoline, and the continued pressure placed on energy-markets by the increasing energy-appetites in China and India. It would also result in less dangerous emissions into the environment. Finally, while research indicates that people drive more when gas price goes down, the road tax will place a drag on driving and fuel consumption regardless of gas price.

Under our system, employers could monitor school bus-drivers who are responsible for millions of young children. Information recorded and transmitted by our hardware could identify unsafe bus-drivers before a tragic accident occurs. Similarly, our system would have detected rollover problems with SUV's long before auto manufacturers lost billions in lawsuits. If there is a structural or engineering flaw in a vehicle design, our system will detect it before the manufacturer is confronted with catastrophic liability problems.

Finally, trucking companies could allocate insurance costs on a per-shipment basis. The load would be valued, and a pre-transit cost assigned which assumed the driver operates the truck in a responsible fashion. If the employer received a higher bill, then the employer would know that such increased cost for insurance was the result of unsafe driving. Needless to say, unsafe truck drivers who drive up costs for transport companies will be identified and removed.

Under our wireless insurance system, people who drive more, and people who drive in a more “dangerous” manner will pay higher insurance rates than those who drive less and drive “safely”. The current system results in a problem that economists refer to as “moral hazard” where there is little incentive to not use a resource [the car and the roadway system] because there is no direct cost assigned to usage. While many insurers have introduced mileage limits reflecting billing, these incentives are relatively modest and unlikely to significantly influence driver behavior.

Moreover, under our system people who “create risk” for the insurer will pay more than those who don't “create risk” for the insurer regardless of whether an accident occurs. People who speed will pay more regardless of whether their speeding results in an accident. People who drive after drinking will pay more regardless of whether they're drinking and driving results in an accident. Regardless of accidents, people who accelerate too quickly, brake more often and hard, and make frequent lane changes at high speeds will pay more under our system. Our system will quickly accumulate and analyze an enormous volume of information, which will enable us to better understand and appreciate what kind of drivers “create risk” for insurers. Using this information, we will become increasingly more efficient at billing drivers based upon profiles of who “create risk” for insurers.

From the foregoing, it will be greatly appreciated that a novel and improved inexpensive self contained vehicle data recorder and telematic device has been devised.

Wherein the magnitude and direction of the kinetic forces that act upon a vehicle during the occurrence of an accident can be recorded to memory and accessed at the scene of that accident for the beneficial use of the vehicle passengers. These forces and measurements include but are not limited to the speed of the vehicle, the direction of the vehicle, the angular forces that result from either a side or front or rear impact, the deceleration forces (g-forces) that result from said impact, the brake activation, seat belt use and the centrifugal forces that result from either a rollover or spin. Amber alert victims or national security subjects can be instantly located via the GPS and communication capabilities of this invention, and interfacing with existing data bases of satellite image providers can provide real time satellite photos of the vehicles location.

Instant access to this vital information allows EMS personnel, police, or homeland security officials to provide a more focused exam and treatment of accident victims while preserving the information coded with the, Date and Time of the accident and the vehicle identification number for the police report and the subsequent analysis of the accident or rescue amber alert victims and/or detain national security subjects of interest. It should be understood that transmission of the electronic information recorded by the current invention such as road use, driver and vehicle performance for insurance purposes, accident reports, and any other information deemed relevant would provide a comprehensive data base on vehicle accidents that could be used as the basis for future research to devise better and safer vehicles.

It is therefore to be understood that various modifications and changes may be made in the method and means and apparatus of the present invention, as well as its' intended application and use without departing from the spirit and scope of the present invention as defined by the following claims.

What is claimed is:

1. A self-contained method and apparatus for the detecting and recording of driver and vehicle operating performance data and response to the kinetic forces that act upon the vehicle during the course of normal operation of the vehicle or in the case of an accident trigger event comprising:
A plurality of electrical connections for collecting pertinent data on various vehicle systems, such data in one preferred embodiment comprised of, vehicle location and direction, the speed of the vehicle, seat belt usage of driver and passengers, forward of reverse gear status, brake activation, and alcohol usage by the operator of the host vehicle said signals being in part analog, and in part digital.

2. A multistage memory scheme comprised of a short term active memory capable of retaining a short time segment of operational data, a second stage cache memory to temporarily store the data transferred from the active memory during the re-write cycle, and a non-volatile memory capable of storing data for periods of up to 10 years or more.

3. The self-contained apparatus of claim 1 wherein said apparatus further comprises:
A re-chargeable back-up battery system for the purpose of enabling the transfer of data recorded in active and cache memory to permanent memory in the event of the interruption of electrical power resulting from anyone of an occurrence of an accident trigger event, or operator action.

4. A self contained apparatus of claim 1, further comprising:
Means for transferring the data stored in permanent memory to a hand held or portable computing device.

5. A self-contained apparatus of claim 1, further comprising:
means of transferring data stored in permanent memory to a host computer via a wireless network on a scheduled basis or in response to the host inquiry.

6. A self-contained apparatus for prevention of vehicle theft and drunk driving comprising:
A numeric keypad with galvanic sensor film to using trans-dermal inputs to measure alcohol or toxicity in human skin.
means of biometric identification with galvanic sensors to using trans-dermal inputs to measure alcohol or toxicity in human skin.

7. A self-contained apparatus as in claim 6 further comprising:
An automotive ignition system to control the operation of an automobile,

8. A logic circuit to receive inputs from the numeric keypad, biometric identification apparatus, and the galvanic sensors causing an induction coil to close a normally open switch to activate the automotive ignition system.

9. A self-contained apparatus to prevent illegal cell phone usage in a moving automobile comprising:
A plurality of electronic devices for voltage regulation, circuit tuning, and electronic noise generation and transmission.

10. A self-contained apparatus to determine real time vehicle location comprising:
A Global positioning system.
means of transferring global positioning data to permanent memory further compising:
means to transfer global position data to host computer via a wireless network.
